(19) United States
(12) Patent Application Publication
(10) Pub. No.: US 2023/0177136 A1
(43) Pub. Date: Jun. 8, 2023

(54) AUTO-PAIRING ROTATION VECTOR

(71) Applicant: QUALCOMM Incorporated, San Diego, CA (US)

(72) Inventors: Diyan TENG, Santa Clara, CA (US); Mehul SOMAN, San Jose, CA (US)

(21) Appl. No.: 17/643,360

(22) Filed: Dec. 8, 2021

(51) Int. Cl. G06F 21/36; G06V 20/20; G06T 11/00; G06T 7/70; G06T 7/30; G06F 21/35

(52) U.S. Cl. CPC G06F 21/36; G06V 20/20; G06T 11/00; G06T 7/70; G06T 7/30; G06F 21/35; G06T 2207/30244

(57) ABSTRACT

Innovative techniques utilize rotation vectors (RV) and game rotation vectors (GRV) for authentication are proposed. The proposed techniques enable auto-pairing of devices when the RVs/GRVs of the devices are aligned with each other. The proposed techniques also enable authentication of a user utilizing RVs/GRVs to a device.

### FIELD OF DISCLOSURE

This disclosure relates generally to pairing of devices, e.g., and in particular to auto-pairing through rotation vectors.

### BACKGROUND

Rotation vector (RV) can be described as a quaternion parameterization of a device's orientation under earth's frame of reference. For example, a fixed orientation reference system may be defined by directions east (E), north (N) and up (U). RV may be specified with one or more values indicating by how many degrees with respect to which axis (E, N, U) a device has rotated. Electronic devices (e.g., smart phones, mobile terminals, smart glasses, wearables, etc.) can be equipped with inertial measurement unit (IMU) sensors (e.g., gyroscope, accelerometer, magnetometer) so that the device can calculate its own RV.

RV has traditionally been used for positioning purposes, e.g., to determine a position of a device, or to determine a change in the device's position. However, the use of RV may be extended beyond that of positioning.

### SUMMARY

The following presents a simplified summary relating to one or more aspects and/or examples associated with the apparatus and methods disclosed herein. As such, the following summary should not be considered an extensive overview relating to all contemplated aspects and/or examples, nor should the following summary be regarded to identify key or critical elements relating to all contemplated aspects and/or examples or to delineate the scope associated with any particular aspect and/or example. Accordingly, the following summary has the sole purpose to present certain concepts relating to one or more aspects and/or examples relating to the apparatus and methods disclosed herein in a simplified form to precede the detailed description presented below.

An exemplary first device is disclosed. The first device may comprise a memory, a communicator, and a processor communicatively connected to the memory and the communicator. The processor may be configured to determine, utilizing an internal measurement unit (IMU), a first rotation vector (RV) of a first camera of the first device. The processor may also be configured to receive one or more RVs from one or more devices including a second RV from a second device. The second RV may be an RV of a second camera of the second device. The processor may further be configured to determine whether the second RV is aligned with the first RV. The processor may yet be configured to auto-pair with the second device (120, 420) when the second RV is aligned with the first RV.

An exemplary method of a first device is disclosed. The method may comprise determining, utilizing an internal measurement unit (IMU), a first rotation vector (RV) of a first camera of the first device. The method may also comprise receiving one or more RVs from one or more devices including a second RV from a second device. The second RV may be an RV of a second camera of the second device. The method may further comprise determining whether the second RV is aligned with the first RV. The method may yet comprise auto-pairing with the second device when the second RV is aligned with the first RV.

Another exemplary first device is disclosed. The first device may comprise means for determining, utilizing an internal measurement unit (IMU), a first rotation vector (RV) of a first camera of the first device. The first device may also comprise means for receiving one or more RVs from one or more devices including a second RV from a second device. The second RV may be an RV of a second camera of the second device. The first device may further comprise means for determining whether the second RV is aligned with the first RV. The first device may yet comprise means for auto-pairing with the second device when the second RV is aligned with the first RV.

A non-transitory computer-readable medium storing computer-executable instructions for a first device configured is disclosed. The computer-executable instructions may comprise one or more instructions instructing the first device to determine, utilizing an internal measurement unit (IMU), a first rotation vector (RV) of a first camera of the first device. The computer-executable instructions may also comprise one or more instructions instructing the first device to receive one or more RVs from one or more devices including a second RV from a second device. The second RV may be an RV of a second camera of the second device. The computer-executable instructions may further comprise one or more instructions instructing the first device to determine whether the second RV is aligned with the first RV. The computer-executable instructions may yet comprise one or more instructions instructing the first device to auto-pair with the second device when the second RV is aligned with the first RV.

An exemplary device is disclosed. The device may comprise a memory, a communicator, and a processor communicatively connected to the memory and the communicator. The processor may be configured to render a virtual scene based on a password of a user. The password may comprise a sequence of one or more symbols. The one or more symbols may comprise one or more visual symbols, one or more sound symbols, or both. The processor may also be configured to determine a selected vector sequence selected by the user within the virtual scene. The selected vector sequence may comprise a sequence of one or more vectors. Each vector may be a rotation vector (RV) or a game rotation vector (GRV). The processor may further be configured to determine whether the selected vector sequence matches the password. The processor may yet be configured to authenticate the user when the selected vector sequence matches the password.

An exemplary method of a device is disclosed. The method may comprise rendering a virtual scene based on a password of a user. The password may comprise a sequence of one or more symbols. The one or more symbols may comprise one or more visual symbols, one or more sound symbols, or both. The method may also comprise determining a selected vector sequence selected by the user within the virtual scene. The selected vector sequence may comprise a sequence of one or more vectors. Each vector may be a rotation vector (RV) or a game rotation vector (GRV). The method may further comprise determining whether the selected vector sequence matches the password. The method may yet comprise authenticating the user when the selected vector sequence matches the password.

Another exemplary device is disclosed. The device may comprise means for rendering a virtual scene based on a password of a user. The password may comprise a sequence of one or more symbols. The one or more symbols may comprise one or more visual symbols, one or more sound symbols, or both. The device may also comprise means for determining a selected vector sequence selected by the user within the virtual scene. The selected vector sequence may comprise a sequence of one or more vectors. Each vector may be a rotation vector (RV) or a game rotation vector (GRV). The device may further comprise means for determining whether the selected vector sequence matches the password. The device may yet comprise means for authenticating the user when the selected vector sequence matches the password.

A non-transitory computer-readable medium storing computer-executable instructions for a device configured is disclosed. The computer-executable instructions may comprise one or more instructions instructing the device to render a virtual scene based on a password of a user. The password may comprise a sequence of one or more symbols. The one or more symbols may comprise one or more visual symbols, one or more sound symbols, or both. The computer-executable instructions may also comprise one or more instructions instructing the device to determine a selected vector sequence selected by the user within the virtual scene. The selected vector sequence may comprise a sequence of one or more vectors. Each vector may be a rotation vector (RV) or a game rotation vector (GRV). The computer-executable instructions may further comprise one or more instructions instructing the device to determine whether the selected vector sequence matches the password. The computer-executable instructions may yet comprise one or more instructions instructing the device to authenticate the user when the selected vector sequence matches the password.

Other features and advantages associated with the apparatus and methods disclosed herein will be apparent to those skilled in the art based on the accompanying drawings and detailed description.

### BRIEF DESCRIPTION OF THE DRAWINGS

A more complete appreciation of aspects of the disclosure and many of the attendant advantages thereof will be readily obtained as the same becomes better understood by reference to the following detailed description when considered in connection with the accompanying drawings which are presented solely for illustration and not limitation of the disclosure.

FIG. 1 illustrates a simplified block diagram of several sample aspects of components that may be employed in devices and configured to support authentication using rotation vectors in accordance with one or more aspects of the disclosure.

FIG. 2 illustrates an environment in which rotation vectors may be used for auto-pairing of devices in accordance with one or more aspects of the disclosure.

FIG. 3 illustrates an example scenario of user-to-user authentication using rotation vectors for auto-pairing of devices in accordance with one or more aspects of the disclosure.

FIG. 4 illustrates a diagram of functions and modules of devices for user-to-user authentication using rotation vectors for auto-pairing in accordance with one or more aspects of the disclosure.

FIGS. 5, 6A, 6B and 7 illustrate flow charts of example methods and processes of using rotation vectors for auto-pairing in accordance with one or more aspects of the disclosure.

FIGS. 8 and 9 illustrate example scenarios of authenticating a user to a device using rotation vectors in accordance with one or more aspects of the disclosure.

FIGS. 10, 11A, 11B, 12, 13 and 14 illustrate flow charts of example methods and processes of using rotation vectors for authenticating a user in accordance with one or more aspects of the disclosure.

FIGS. 15 and 16 illustrate simplified block diagrams of several sample aspects of devices configured to utilize rotation vectors for user-to-user and user-to-device authentication in accordance with one or more aspects of the disclosure.

FIG. 17 illustrates various electronic devices which may utilize one or more aspects of the disclosure.

Other objects and advantages associated with the aspects disclosed herein will be apparent to those skilled in the art based on the accompanying drawings and detailed description. In accordance with common practice, the features depicted by the drawings may not be drawn to scale. Accordingly, the dimensions of the depicted features may be arbitrarily expanded or reduced for clarity. In accordance with common practice, some of the drawings are simplified for clarity. Thus, the drawings may not depict all components of a particular apparatus or method. Further, like reference numerals denote like features throughout the specification and figures.

### DETAILED DESCRIPTION

Aspects of the present disclosure are illustrated in the following description and related drawings directed to specific embodiments. Alternate aspects or embodiments may be devised without departing from the scope of the teachings herein. Additionally, well-known elements of the illustrative embodiments herein may not be described in detail or may be omitted so as not to obscure the relevant details of the teachings in the present disclosure.

In certain described example implementations, instances are identified where various component structures and portions of operations can be taken from known, conventional techniques, and then arranged in accordance with one or more exemplary embodiments. In such instances, internal details of the known, conventional component structures and/or portions of operations may be omitted to help avoid potential obfuscation of the concepts illustrated in the illustrative embodiments disclosed herein.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

As indicated above, many devices (e.g., smart phones, mobile terminals, smart glasses, etc.) may be able to calculate its own RV based on measurements from IMU sensors (e.g., gyroscope, accelerometer, magnetometer, etc.). The gyroscope may provide an instantaneous rotation (e.g., angle, velocity) measurement. That is, the gyroscope may measure how fast the device is rotating.

Accelerometer typically provides gravity direction within the measure frame. That is, the accelerometer can provide the direction of gravity with respect to the current orientation of the device. Thus, the accelerometer can be used to verify and/or correct orientation change reported by the gyroscope with respect to gravitational information.

Magnetometer typically provides orientation of the device with respect to magnetic north.

Alternatively or in addition thereto, if the magnetometer (or the device itself) is calibrated, orientation with respect to true north may be provided. Thus, the magnetometer may be used to verify and/or correct orientation change reported by the gyroscope with respect to earth's north direction. Note that if only a change with respect to the north direction is of interest, the difference between true and magnetic north may not be of concern. Note that devices may also calculate game RVs (GRV) instead of or in addition to its RV. In GRV, the Y axis need not point to north, but may point to a direction in some other reference.

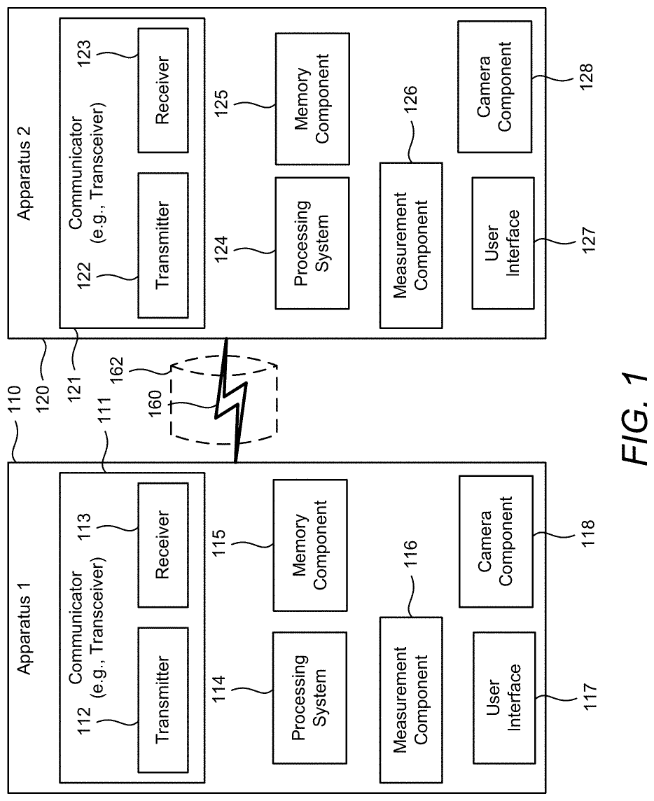

FIG. 1 illustrates several sample components (represented by corresponding blocks) that may be incorporated into apparatuses 110 and 120 to support the operations as disclosed herein. As an example, one or both apparatuses 110, 120 may correspond to an end user device such as a smart phone (also referred to as a user equipment (UE)), a wearable unit such as smart glasses (e.g., for augmented reality (AR), extended reality (XR), etc.), a mobile device, and so on. In another example, one or both apparatuses may correspond may correspond to a terminal or a server that provides services to end users.

It will be appreciated that the components may be implemented in different types of apparatuses in different implementations (e.g., in an ASIC, in a System-on-Chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The apparatuses 110, 120 may each include at least one communicator (represented by communicators 111, 121) for communicating with other devices. The communicators 111, 121 may be capable of communicating through wired and/or or wireless protocols (e.g., wi-fi, Bluetooth, LTE, New Radio (NR), etc.). The communicator 111 may include at least one transmitter (represented by transmitter 112) for transmitting and encoding signals (e.g., messages, indications, information, and so on) and at least one receiver (represented by receiver 113) for receiving and decoding signals (e.g., messages, indications, information, pilots, and so on). The communicator 111 may also be referred to as a transceiver. The communicator 121 may include at least one transmitter (represented by transmitter 122) for transmitting signals (e.g., messages, indications, information, pilots, and so on) and at least one receiver (represented by receiver 123) for receiving signals (e.g., messages, indications, information, and so on). The communicator 111 may also be referred to as a transceiver.

A transmitter and a receiver may comprise an integrated device (e.g., embodied as a transmitter circuit and a receiver circuit of a single communicator) in some implementations, may comprise a separate transmitter device and a separate receiver device in some implementations, or may be embodied in other ways in other implementations. In an aspect, a transmitter may include a plurality of antennas, such as an antenna array, that permits the respective apparatus to perform transmit “beamforming,” as described further herein. Similarly, a receiver may include a plurality of antennas, such as an antenna array, that permits the respective apparatus to perform receive beamforming, as described further herein. In an aspect, the transmitter and receiver may share the same plurality of antennas, such that the respective apparatus can only receive or transmit at a given time, not both at the same time. A wireless communicator (e.g., one of multiple wireless communicators) of the apparatus 120 may also comprise a Network Listen Module (NLM) or the like for performing various measurements.

The apparatuses 110, 120 may also include other components used in conjunction with the operations as disclosed herein. The apparatus 110 may include a processing system 114 for providing functionality relating to, for example, communication with other devices, authentication, rotation vector functions, AR/XR functions, object detection, etc. The apparatus 120 may include a processing system 124 for providing functionality relating to, for example, communication with other devices, authentication, rotation vector functions, AR/XR functions, object detection, etc. In an aspect, the processing systems 114, 124 may each include, for example, one or more general purpose processors, multi-core processors, ASICs, digital signal processors (DSPs), field programmable gate arrays (FPGA), other programmable logic devices, processing circuitry, or any combination thereof.

The apparatuses 110, 120 may include measurement components 116 and 126, respectively, for obtaining RV measurements. The measurement component 116 may measure rotation vectors associated with the apparatus 110. The measurement component 116 may comprise a gyroscope, an accelerometer, a magnetometer, or any combination thereof. Similarly, the measurement component 126 may measure rotation vectors associated with the apparatus 120. The measurement component 126 may comprise a gyroscope, an accelerometer, a magnetometer, or any combination thereof. The measurement components 116, 126 may also be referred to as inertial measurement units (IMU) of the apparatuses 110, 120.

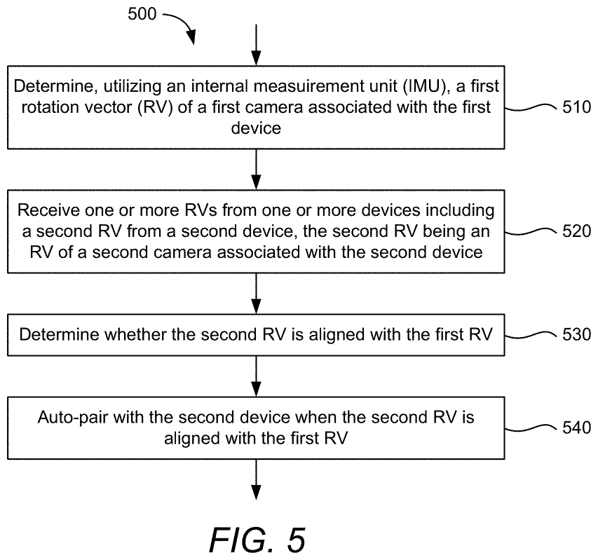

The apparatuses 110, 120 may include memory components 115 and 125 (e.g., each including a memory device), respectively, for maintaining information (e.g., information indicative of reserved resources, thresholds, parameters, and so on). In various implementations, the memory 115 may comprise a computer-readable medium storing one or more computer-executable instructions where the one or more instructions instruct the apparatus 110 (e.g., the processing system 114 in combination with other aspects of the apparatus 110) to perform any of the methods of FIGS. 5-7 and 10-14. Also in various implementations, the memory 125 may comprise a computer-readable medium storing one or more computer-executable instructions where the one or more instructions instruct the apparatus 120 (e.g., the processing system 124 in combination with other aspects of the apparatus 120) to perform any of the methods of FIGS. 5-7 and 10-14.

In addition, the apparatuses 110, 120 may include user interfaces 117 and 127, respectively, for providing indications (e.g., audible, visual, and or haptic indications) to a user and/or for receiving user input (e.g., upon user actuation of a sensing device such a keypad, a touch screen, a microphone, haptic actuators, and so on).

The apparatuses 110, 120 may respectively include camera components 118 and 128 for providing views, e.g., to take still pictures and/or record videos. In one aspect, the camera component 118 may be housed within the apparatus 110 (e.g., a camera of a mobile phone). Alternatively or in addition thereto, the camera component 118 may be housed in a separate unit, and a communication link (wired or wireless) may be established between the camera component 118 and the apparatus 110. Similarly, the camera 128 may be housed within the apparatus 120 (e.g., a camera of a mobile phone). Alternatively or in addition thereto, the camera 128 may be housed in a separate unit, and a communication link (wired or wireless) may be established between the camera 128 and the apparatus 120.

For convenience, the apparatuses 110, 120 are shown in FIG. 1 as including various components that may be configured according to the various examples described herein. It will be appreciated, however, that the illustrated blocks may have different functionality in different designs. The components of FIG. 1 may be implemented in various ways. In some implementations, the components of FIG. 1 may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all functionalities represented by blocks 111, 114, 115, 116, 117 and 118 may be implemented by processor and memory component(s) of the apparatus 110 (e.g., by execution of appropriate code and/or by appropriate configuration of processor components). Similarly, some or all functionalities represented by blocks 121, 120, 124, 125, 126, 127 and 128 may be implemented by processor and memory component(s) of the apparatus 120 (e.g., by execution of appropriate code and/or by appropriate configuration of processor components).

The apparatus 110 may transmit and receive messages via a link 160, which may be wireless, with the apparatus 120, the messages including information related to various types of communication (e.g., voice, data, multimedia services, associated control signaling, etc.). The wireless link 160 may operate over a communication medium of interest, shown by way of example in FIG. 1 as the medium 162, which may be shared with other communications as well as other radio access technologies (RATs). A medium of this type may be composed of one or more frequency, time, and/or space communication resources (e.g., encompassing one or more channels across one or more carriers) associated with communication between one or more transmitter/receiver pairs, such as the apparatus 120 and the apparatus 110 for the medium 162.

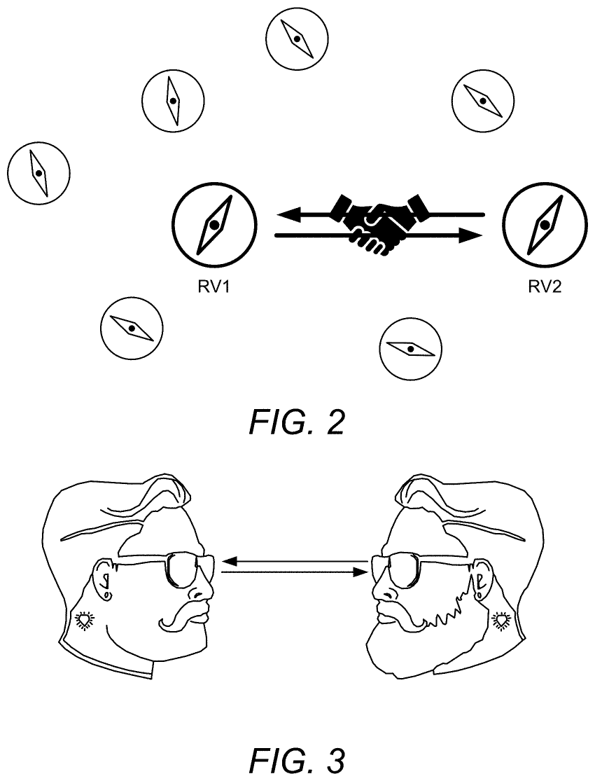

In an aspect, it is proposed to use RV as a protocol for device pairing, e.g., auto-pairing of devices. FIG. 2 illustrates an environment in which RVs may be used for auto-pairing of devices. One or more devices within a neighborhood may each continually update a list of existing nearby devices, e.g., by using software over the air (SOTA) connectivity technologies. Each device may compute its own RV, e.g., on its own processor. The RV may be broadcasted in network packets proactively. A device may be paired up with another device by confirming its RV is aligned with the RV of that another device.

For illustration purposes, RVs of associated with various devices are shown in FIG. 2. The RVs may be broadcasted by the respective devices. Here, RV1 may be assumed to represent the RV associated with a first device and RV2 may be assumed to represent the RV associated with the second device, and operations may be performed to pair the first and second devices with each other. While either the first or the second device may initiate the auto-pairing operations, it will be assumed that the first device initiates in the following description.

The first device may recognize that RV2 is aligned with RV1. For example, the first device may confirm that RV2 is in opposite direction to RV1 (plus or minus a threshold angle). In other words, the first and second devices (or at least their cameras) may be facing each other. Alternatively or in addition thereto, the first device may confirm that RV2 is in a same direction to RV1 (again plus or minus the threshold angle). Note that direction of pairing may be a designer choice. The threshold angle may be based on accuracies of measurement components of the devices, security requirements, etc.

Upon determining that the RV1 and RV2 are aligned, the first device may automatically pair with the second device. Once paired, the first and second devices may exchange information with each other. For example, the first device may send a view to the second device. The view may be a first camera view (view of its camera) and/or a rendered view, e.g., by processing the first camera view with AR and/or XR rendering. Alternatively or in addition thereto, the first device may receive a view from the second device. This view may be a second camera view (view of the camera of the second device) and/or a rendered second camera view. In an aspect, the first device may further process the view received from the second device.

One area in which the proposed auto-pairing may be used is in user-to-user (U2U) authentication, for example, in AR/XR situations. Enabling AR/XR use cases (e.g., gaming, navigation, business collaboration) can be of great value. Various form factors (e.g., smartphone, wearables, etc.) may be supported. FIG. 3 illustrates an example illustrates an example scenario of U2U authentication using auto-pairing in RV. Here, the two users are assumed to be wearing smart glasses such as AR/XR capable glasses. Content of first user's glasses may be shared with second user's glasses, and vice versa. When both users look at each other (e.g., for a threshold time such as few seconds), the devices may pair-up with each other. By letting the users look at each other, two conditions may be guaranteed: 1) The respective RVs will be in opposite directions for alignment and/or registration, and 2) Computer vision algorithms from the AR/XR glasses may be used to confirm that there is a second user in the visible region. AR/XR rendering may then respectively compute a common virtual scene from each device's view angle.

While the scenario illustrated in FIG. 3 is described as U2U auto-pairing, it may also be viewed as device-to-device (D2D) auto-pairing since in reality, the first and second devices are being auto-paired. However, U2U is also appropriate since the auto-pairing may be caused by actions of the users of the first and second devices.

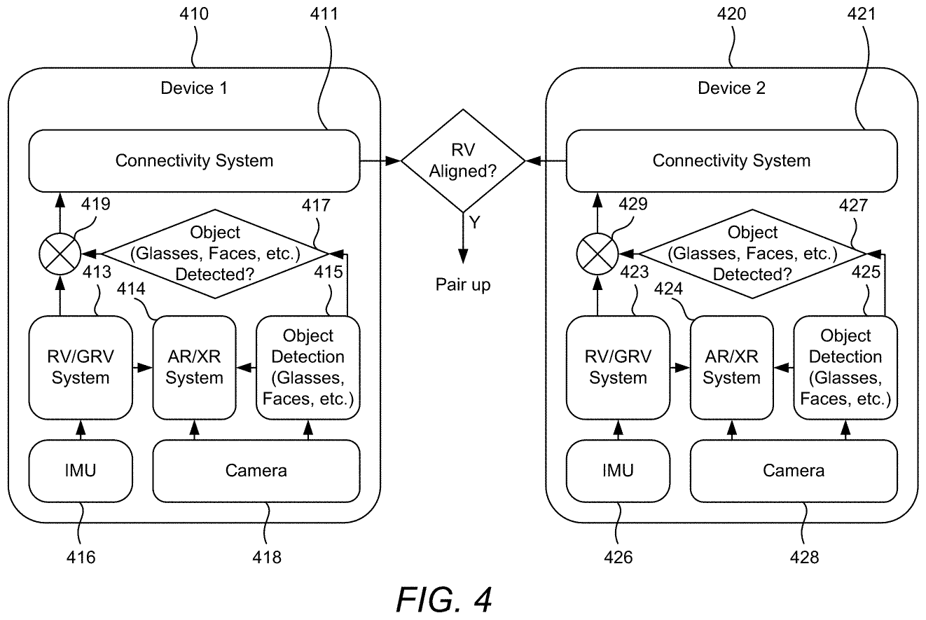

FIG. 4 illustrates a diagram of systems and modules of devices for U2U authentication using rotation vectors for auto-pairing. Device 1 (or first device 410) may include the following: connectivity system 411, RV/GRV system 413, AR/XR system 414, object detection 415, IMU 416, decision module 417, camera 418 and selector 419. Each system or module 411, 413, 414, 415, 416, 417, 418 and 419 may be implemented in hardware or in a combination of hardware and software. For example, each system or module 411, 413, 414, 415, 416, 417, 418 and 419 may be implemented through a hardware circuitry or through one or more components of apparatus 110 of FIG. 1.

Similarly, device 2 (or second device 420) may include the following: connectivity system 421, RV/GRV system 423, AR/XR system 424, object detection 425, IMU 426, decision module 427, camera 428 and selector 429. Each system or module 421, 423, 424, 425, 426, 427, 428 and 429 may be implemented in hardware or in a combination of hardware and software. For example, each system or module 421, 423, 424, 425, 426, 427, 428 and 429 may be implemented through a hardware circuitry or through one or more components of apparatus 120 of FIG. 1.

In FIG. 4, the processes performed by the first device 410 may be similar the processes of the second device 420. Hence, the systems and modules of the first device 410 will be described with the understanding that the description may apply to the systems and modules of the second device 420. In the first device 410, the RV/GRV system 413 may determine how the first device 410 is rotating based on measurements from the IMU 416. In an aspect, the RV/GRV system 413 may be implemented through a processor (e.g., processing system 114) and/or a memory (e.g., memory component 115). The IMU 416 may be implemented through a measurement component (e.g., e.g., measurement component 116).

The object detection 415 may perform computer vision processing of views from the camera 418. For example, the object detection 415 may analyze what is in front of the camera 418 (e.g., what is in front of the AR/XR smart glasses) to detect one or more objects of interest. The objects of interest may include a wearable unit such as smart glasses (e.g., AR/XR glasses of second user), a human face (e.g., face of second user), a mobile device (e.g., the second device 420 held by the second user), etc. In an aspect, the object detection 415 may be implemented through a processor (e.g., processing system 114) and/or a memory (e.g., memory component 115). The camera 418 may be implemented through a camera component (e.g., e.g., camera component 118).

In decision module 417, it may be determined whether the object of interest is detected. If so (i.e., object is in view of the camera 418), then the first RV (i.e., RV of the first device 410) may be provided to the connectivity system 411 (e.g., through a mixer or selector 419). The connectivity system 411 may broadcast the first RV to other devices including to the second device 420 as part of a network protocol. The connectivity system 411 may also receive the second RV from the second device 420. The connectivity system 411 may then auto-pair the first device 410 with the second device 420 if the first and second RVs are aligned with each other. In general, auto-pairing may be viewed as pairing of the first and second devices automatically taking place upon determination that the devices are aligned with each other. In an aspect, the decision module 417 may be implemented through a processor (e.g., processing system 114) and/or a memory (e.g., memory component 115). The connectivity system 411 may be implemented through a processor (e.g., processing system 114), a memory (e.g., memory component 115), and/or a communicator (e.g., communicator 111). The selector 419 may be implemented through a processor (e.g., processing system 114) and/or a memory (e.g., memory component 115).

FIG. 5 illustrates a flow chart of an example method 500 performed by a device of using RVs for auto-pairing. The method 500 may also be viewed as an example method of performing U2U authentication through RVs. The method 500 may be performed by a device such as any of the devices 110, 120, 410, 420. For ease of reference, the details of the method 500 will be described from the perspective of a first device (e.g., devices 110, 410) performing the method 500. Then the memory component 115 may be an example of a non-transitory computer-readable medium storing executable instructions for the first device to perform the method 500.

In block 510, the first device (e.g., RV/GRV system 413, IMU 416) may determine a first rotation vector (RV) of a first camera (e.g., camera 418) of the first device. Means for performing block 510 may include the measurement component 116, the processing system 114, and/or the memory component 115 of the apparatus 110. The camera component 118 of the apparatus 110 may be an example of the first camera.

In block 520, the first device (e.g., connectivity system 411) may receive one or more RVs from one or more devices. Means for performing block 520 may include the communicator 111, the processing system 114, and/or the memory component 115 of the apparatus 110. Among the one or more RVs may be a second RV from a second device (e.g., apparatus 120, 420). The second RV may be an RV of a second camera (e.g., camera 428) of the second device.

In block 530, the first device (e.g., RV/GRV system 413) may determine whether the second RV is aligned with the first RV. Means for performing block 530 may include the processing system 114 and/or the memory component 115 of the apparatus 110.

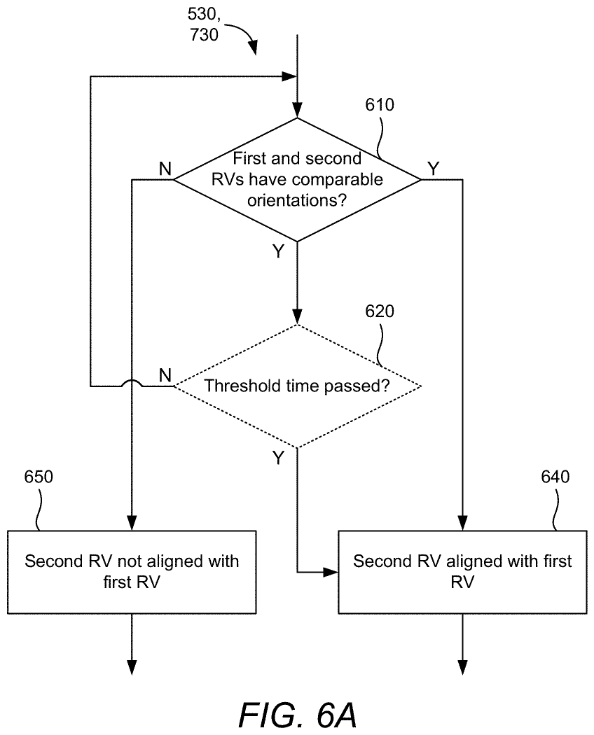

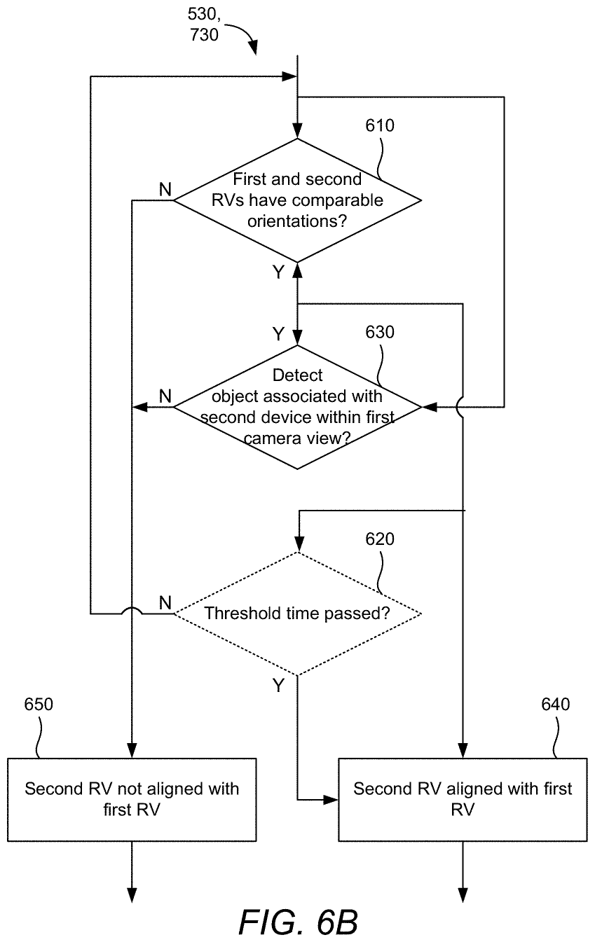

FIG. 6A illustrates a flow chart of an example process that may be performed by the first device to implement block 530. In block 610, the first device (e.g., RV/GRV system 413) may determine whether the first and second RVs have comparable orientations. Means for performing block 610 may include the processing system 114 and/or the memory component 115 of the apparatus 110.

In one aspect, the orientations of the first and second RVs may be deemed comparable if they are in opposite orientations. For example, the cameras of the first and second devices may be facing each other. This is the situation illustrated in FIG. 3 in which the first and second users are looking at each other. To allow for measurement errors, the first and second RVs may be deemed to be aligned when they are in opposite orientations with each other within a threshold angle. For example, if the first RV is in a zero degree orientation (however such orientation may be defined) and the threshold angle is three degrees, then the second RV may be deemed to be aligned if it is in between 177 and 183 degree orientations. Note that the threshold angle may also be set to require some amount of precision from the users.

Alternatively, the orientations of the first and second RVs may be deemed comparable if they are in a same orientation. For example, the cameras of the first and second devices may be looking in a same direction. Again, measurement errors may be taken into account. That is, the first device may determine that the first and second RVs are aligned when they are in a same orientation with each other within the threshold angle tolerance.

If the first device determines that the first and second RVs do not have comparable orientations (‘N’ branch from block 610), then in block 650, the first device may determine that the first and second RVs are not aligned. Means for performing block 650 may include the processing system 114 and/or the memory component 115 of the apparatus 110.

On the other hand, if the first device determines that the first and second RVs do have comparable orientations (‘Y’ branch from block 610), then in block 640, the first device may determine that the first and second RVs are aligned. Means for performing block 640 may include the processing system 114 and/or the memory component 115 of the apparatus 110.

But in an aspect, it may be desirable to verify that the users have intended the alignment of the RVs. One way for the users to show intent is to maintain the alignment of the RVs for a threshold time, e.g., such as two seconds. For example, in FIG. 3, if the users continue to look at each other for the threshold time, then it may be deemed that the alignment of the first and second RVs are intentional. Block 620 is provided as a dashed box to indicate that it may be optional.

In this aspect, if the first device determines that the first and second RVs do have comparable orientations (‘Y’ branch from block 610), then in block 620, the first device may determine whether the threshold time has passed. Means for performing block 620 may include the processing system 114 and/or the memory component 115 of the apparatus 110.

If the first device determines that the threshold time has not yet passed (‘N’ branch from block 620), the first device may proceed back to block 610 to determine whether the orientations of the first and second RVs remain comparable. This implies that the first and/or the second devices may continually monitor and broadcast their respective RVs. That is, blocks 510 and 520 may continually be performed. If the first device determines that the threshold time has passed (‘Y’ branch from block 620), the first device may proceed back to block 640 to determine that the first and second RVs are aligned.

Alternatively, there may yet be a further check performed determine whether the first and second RVs are aligned. In this alternative aspect, in addition to the first and second RVs having comparable orientations, it may also be required to determine that the first and second users are actually facing each other. To state it another way, it may also be required that objects associated with the devices be visible to each other.

This is illustrated in FIG. 6B. In block 610, the first device (e.g., RV/GRV system 413) may determine whether the first and second RVs have comparable orientations. Means for performing block 610 may include the processing system 114 and/or the memory component 115 of the apparatus 110. Details of an example way to determine whether the first and second RVs have comparable orientations are discussed above, and thus will not be repeated here for brevity.

In block 630, the first device (e.g., object detection 415, camera 418) may detect whether an object associated with the second device is within a view of the first camera. In other words, the first device may determine whether an object of interest is within the view of the first camera. For ease of reference, this view may also be referred to as the first camera view. Such objects may include a face (e.g., a face of user), a wearable unit (e.g., smart glasses), a mobile device (e.g., the second device itself), etc. Means for performing block 630 may include the camera component 118, the processing system 114, and/or the memory component 115 of the apparatus 110.

If the first device determines that the first and second RVs do not have comparable orientations (‘N’ branch from block 610) or determines that the object associated with the second device is not within the first camera view (‘N’ branch from block 630), then in block 650, the first device may determine that the first and second RVs are not aligned. Means for performing block 650 may include the processing system 114 and/or the memory component 115 of the apparatus 110.

On the other hand, if the first device determines that the first and second RVs do have comparable orientations (‘Y’ branch from block 610) and determines that the object associated with the second device is within the first camera view (‘Y’ branch from block 630), then in block 640, the first device may determine that the first and second RVs are aligned. Means for performing block 640 may include the processing system 114 and/or the memory component 115 of the apparatus 110.

Note that in FIG. 6B, if both blocks 610 and 630 evaluate to be true, then the first and second RVs may be determined to be aligned in block 640. If block 610 and/or block 630 evaluates to be false, then then the first and second RVs may be determined to be not aligned in block 650.

In an aspect, the first device may perform blocks 610 and 630 in parallel, perform block 610 followed by block 630, or perform block 630 followed by block 610. If blocks 610 and 630 are performed in parallel, it may result in a faster execution relative to performing the blocks serially. For example, if both blocks 610 and 630 evaluate to true, performing these blocks in parallel should be faster than performing them serially. Of course, if block 610 (630) evaluates to false, performance of block (630 (610) maybe stopped.

In one aspect, if block 610 is performed first, then block 630 may be performed only when block 610 determines that there is a second RV aligned with the first RV. That is, block 630 may serve as a confirmation of block 610. In another aspect, if block 630 is performed first, then block 610 may be performed only when block 630 detects that an object of interest is within the first camera view. That is, block 610 may serve as a confirmation of block 630. In this instance, a low resolution camera may be sufficient. If blocks 610 and 630 are performed sequentially, there may be some power savings relative to performing blocks 610 and 630 in parallel. For example, if block 610 (630) is performed first and evaluates to false, then other block 630 (610) need not be performed at all.

In an aspect, it may again be desirable to verify that the users have intended the alignment of the RVs, e.g., by maintaining the alignment of the RVs within each other's view for a threshold time. In this aspect, if the first device determines that the first and second RVs do have comparable orientations (‘Y’ branch from block 610) and that that the object associated with the second device is within the first camera view (‘Y’ branch from block 630), then in block 620, the first device may determine whether the threshold time has passed. Means for performing block 620 may include the processing system 114 and/or the memory component 115 of the apparatus 110.

If the first device determines that the threshold time has not yet passed (‘N’ branch from block 620), the first device may proceed back to block 610 (to determine whether the orientations of the first and second RVs remain comparable) and block 630 (to determine whether the object associated with the second device remains in the first camera view). This again implies that the first and/or the second devices may continually monitor and broadcast their respective RVs. If the first device determines that the threshold time has passed (‘Y’ branch from block 620), the first device may proceed back to block 640 to determine that the first and second RVs are aligned.

Referring back to FIG. 5, when it is determined that the first and second RVs are aligned, the first device (e.g., connectivity system 411) in block 540 may auto-pair with the second device. That is, upon determining that the first and second devices are aligned in block 530, the first device (e.g., RV/GRV system 413) may immediately proceed to pairing with second device. For example, the first device may pair with the second device without further input from the user of the first device. Means for performing block 540 may include the communicator 111, the processing system 114 and/or the memory component 115 of the apparatus 110.

Alternatively, while not shown, the first device may request the user permission to pair with the second device upon determining that the first and second devices are aligned in block 530. In this alternative aspect, the pairing may take place when an input from the user indicates that the permission to pair is granted.

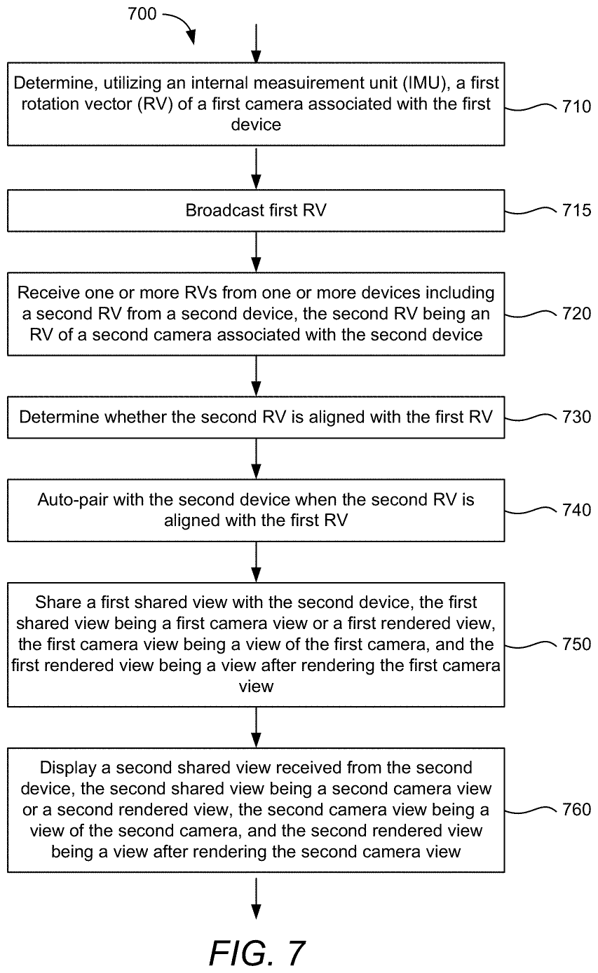

FIG. 7 illustrates a flow chart of an example method 700 performed by a device of using RVs for auto-pairing. The method 700 may be a more detailed version of the method 500, and thus may also be viewed as an example method of performing U2U authentication through RVs. Again, the description of the method 700 will be provided from the perspective of the first device (e.g., devices 110, 410) recognizing that the method may also apply to other devices such as the second device (e.g., devices 120, 420). The memory component 115 may be an example of a non-transitory computer-readable medium storing executable instructions for the first device to perform the method 700.

In block 710, the first device may determine a first rotation vector (RV) of a first camera of the first device. Block 710 may be assumed to be similar to block 510. Therefore, a detailed description thereof will be omitted for sake of brevity.

In block 715, the first device (e.g., connectivity system 411) may broadcast the first RV, e.g., to other devices within a neighborhood of the first device. Means for performing block 715 may include the communicator 111, the processing system 114, and/or the memory component 115 of the apparatus 110.

In block 720, the first device may receive one or more RVs from one or more devices, including the second RV from the second device. Block 720 may be assumed to be similar to block 520. Therefore, a detailed description thereof will be omitted for sake of brevity. Note that blocks 710, 715 and 720 may be continually performed.

In block 730, the first device may determine whether the second RV is aligned with the first RV. Block 730 may be assumed to be similar to block 530 including blocks of FIGS. 6A and 6B. Therefore, a detailed description thereof will be omitted for sake of brevity.

When it is determined that the first and second RVs are aligned, the first device in block 740 may auto-pair with the second device. Block 740 may be assumed to be similar to block 540. Therefore, a detailed description thereof will be omitted for sake of brevity.

After auto-pairing with the second device, the first device (e.g., AR/XR system 414, camera 418, connectivity system 411) in block 750 may share information with the second device. Means for performing block 750 may include the communicator 111, the camera component 118, the processing system 114, and/or the memory component 115 of the apparatus 110.

The shared information may include a first shared view. In an aspect, the first shared view may simply be a view of the first camera, e.g., the view captured by the first camera without any augmentations or extensions. Such view may also be referred to as the first camera view. Alternatively or in addition thereto, the first shared view may be a rendered version of the first camera view, which also may be referred to as the first rendered view. For example, the first rendered view may be an augmented reality view of the first camera view, an extended reality view of the first camera view, or both.

Instead of or in addition to sharing the first shared view, the first device (e.g., AR/XR system 414, connectivity system 411) in block 760 may display a second shared view received from the second device. Block 760 may be performed after auto-pairing with the second device in block 740. Means for performing block 750 may include the communicator 111, the user interface 117, the processing system 114, and/or the memory component 115 of the apparatus 110.

The second shared view may simply be a view of the second camera of the second device, e.g., the view captured by the second camera without any augmentations or extensions, which may also be referred to as the second camera view. Alternatively or in addition thereto, the second shared view may be a rendered version of the second camera view, which also may be referred to as the second rendered view. For example, the second rendered view may be an augmented reality view of the second camera view, an extended reality view of the second camera view, or both. Note that the first device may render the second camera view and/or further render the second rendered view.

As described with respect to FIGS. 2-7, RV may be used in U2U authentication (more equivalently D2D authentication) implemented through auto-pairing of devices. However, it is also proposed to use RV for user-to-device (U2D) authentication. That is, it is proposed to use RV as a protocol for authenticating a user to a device. This may be viewed as another way of implementing a login procedure to authenticate a user to a device. The user may pre-register a personal identification number (PIN) code. The PIN code may also be referred to as a password.

In an AR/XR scene, the device may render a virtual scene that includes the user's PIN and another set of randomly generated different characters. In the virtual scene, the characters may be placed randomly in space. The device may compute the RV/GRV (game RV). The user may select a password (i.e., PIN) sequence by turning sequentially to each character and maintain for a short while on each character. The device may compare the on-device RV/GRV logs with the ground truth used during rendering to provide a pass/fail. In an aspect, the virtual scene may be bigger than a viewable scene. For example, the virtual scene may be greater than a field of view (FOV) of the AR/XR glasses. The user may pan different portions of the virtual scene when the device's FOV is less than the virtual scene.

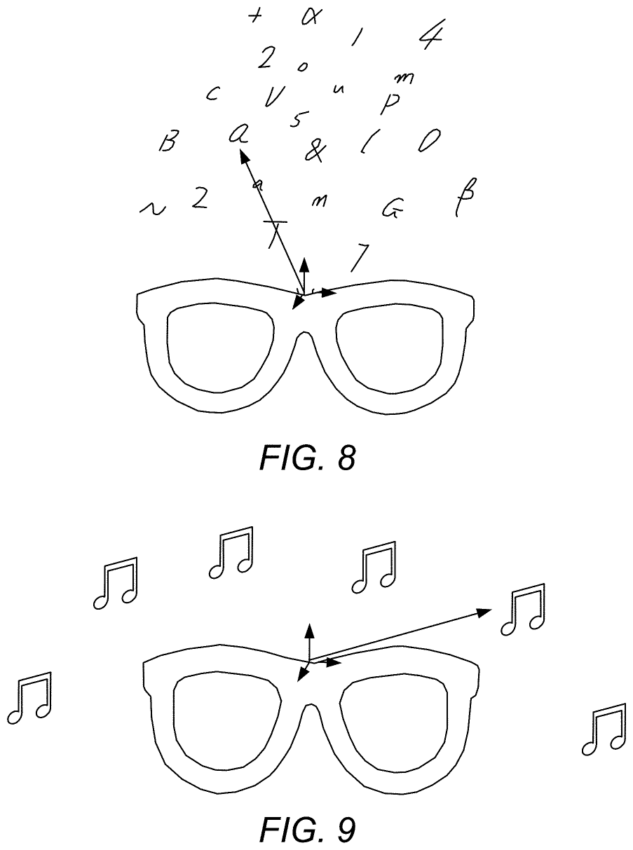

FIG. 8 illustrates an example scenario of authenticating a user to a device using rotation vector. In particular, FIG. 8 illustrates an example of a virtual scene rendered by the device. A set of characters may be distributed throughout the rendered scene. The characters may vary in a number of ways including color, font, size, etc. This implies that PINs may be differentiated based on characteristics other than simply a sequence of characters. For example, a blue ‘Q’ in blue may be differentiated from a letter ‘Q’. As another example, a Times Roman font ‘Q’ may be differentiated from a Bookman font ‘Q’. Still further, a 12-point ‘Q’ may be differentiated from a 10-point ‘Q’. Also, different levels of security may be implemented. For example, RV/GRV detection may require different levels of precision for different levels of security requirements.

While FIG. 8 illustrates characters as being displayed in the virtual scene, this should not be taken as a limitation. Other types of visual components (e.g., icons, emojis, etc.) may be displayed as well. Therefore, it may be said that the device may render a virtual scene that includes a set of symbols. The symbols may be any combination of visual elements such as characters, icons, emojis, etc. Again, the symbols may be differentiated based on any characteristics (e.g., color, size, font, etc.).

Alternatively or in addition thereto, if spatial audio is available in the device, the password may include one or more pre-defined sounds. This is illustrated in FIG. 9. When a pre-defined sound event occurs (e.g., 45 degrees to the right), the user may respond by reorienting the device so that the sound event is in the center. For example, assume that the pre-defined sound of the password includes a waterfall sound. Within the virtual audio scene, the device may render the password sound (e.g., the waterfall sound) with a random direction associated with an RV. Along with the password sound, the device may also render another sound (e.g., glass breaking) associated with a different RV. Then to unlock, the user should track—among the sounds rendered—the sound associated with the password sound, e.g., by turning the device to center the sound. The RV of the password sound may change at different authentication times, and the user should track the sound each time for authentication.

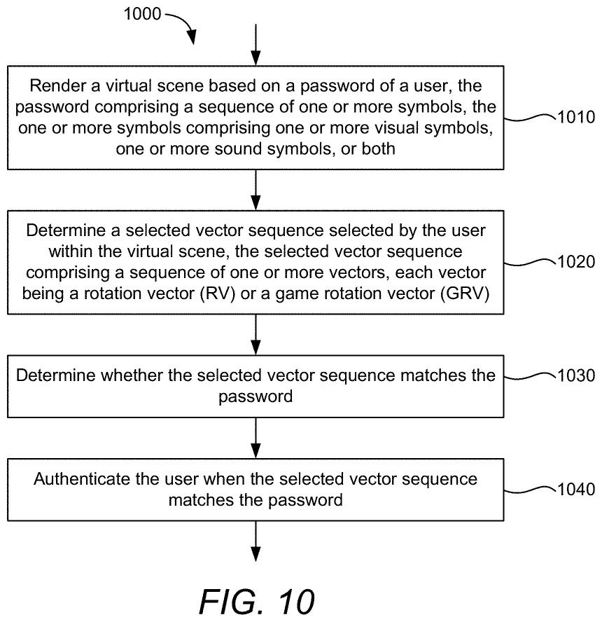

FIG. 10 illustrates a flow chart of an example method 1000 performed by a device of using RVs for authenticating a user. The method 1000 may also be viewed as an example method of performing U2D authentication through RVs. The method 1000 may be performed by a device such as any of the devices 110, 120, 410, 420. For ease of reference, the details of the method 1000 will be described from the perspective of a device 110 or 410 as performing the method 1000. Then the memory component 115 may be an example of a non-transitory computer-readable medium storing executable instructions for the first device to perform the method 1000.

In block 1010, the device (e.g., AR/XR system 414) may render a virtual scene based on a password of a user. The password may be pre-registered with the device and may comprise a sequence of one or more symbols. The symbols of the password may comprise one or more visual symbols, one or more sound symbols, or both. Means for performing block 1010 may include the user interface 117, the processing system 114, and/or the memory component 115 of the apparatus 110. It should be noted that for visual symbols, a visual symbol may be differentiated from another visual symbol based on one or more characteristics such as color, font (if symbol is character), size, and so on.

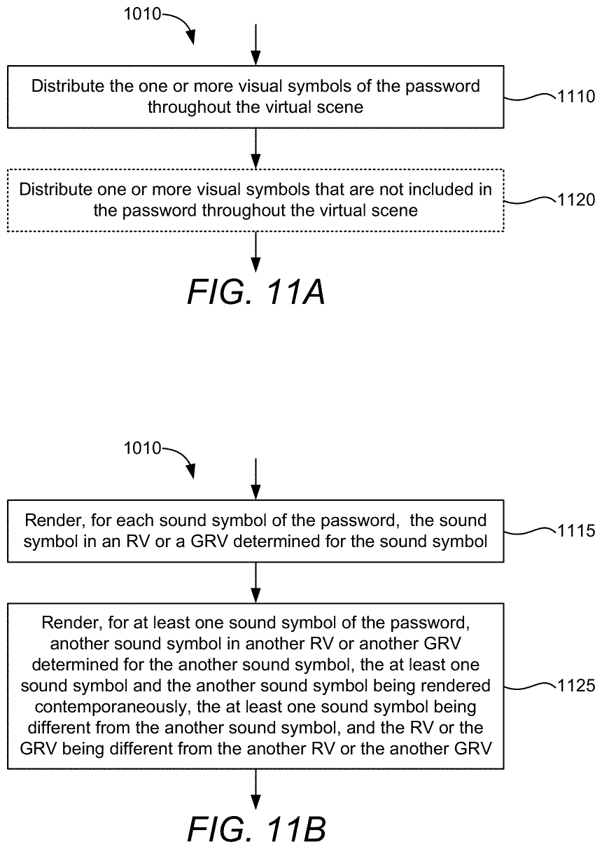

FIG. 11A illustrates a flow chart of an example process that may be performed by the device to implement block 1010 if the password includes one or more visual symbols. In block 1110, the device (e.g., RG/GRV system 413, AR/XR system 414) may distribute the visual symbols of the password throughout the virtual scene. Means for performing block 1110 may include the user interface 117, the processing system 114, and/or the memory component 115 of the apparatus 110. In an aspect, the visual symbols may be distributed randomly. For example, the distribution of the visual symbols of the password in one authentication attempt may be different from the distribution of the visual symbols of the password in another authentication attempt.

Optionally, in block 1120, the device (e.g., RG/GRV system 413, AR/XR system 414) may distribute one or more visual symbols that are not included in the password throughout the virtual scene. Means for performing block 1120 may include the user interface 117, the processing system 114, and/or the memory component 115 of the apparatus 110. In an aspect, these non-password visual symbols may be randomly generated. For example, the non-password visual symbols generated in one authentication attempt may not be the same as the non-password visual symbols generated in another authentication attempt. Alternatively or in addition thereto, These non-password visual symbols may be randomly distributed. For example, the distribution of the non-password visual symbols in one authentication attempt may be different from the distribution of the non-password visual symbols in another authentication attempt.

FIG. 11B illustrates a flow chart of an example process that may be performed by the device to implement block 1010 if the password includes one or more sound symbols. In block 1115, for each sound symbol of the password, the device (e.g., RG/GRV system 413, AR/XR system 414) may render the sound symbol in an RV or GRV determined for the sound symbol. Means for performing block 1115 may include the user interface 117, the processing system 114, and/or the memory component 115 of the apparatus 110. In an aspect, the RV or the GRV for the sound symbol may be randomly determined. For example, the RV or the GRV determined for the sound symbol in one authentication attempt may be different from the RV or the GRV determined for the sound symbol in another authentication attempt.

In block 1125, for at least one sound symbol of the password, the device (e.g., RG/GRV system 413, AR/XR system 414) may render another sound symbol in another RV or another GRV determined for the another sound symbol. Means for performing block 1125 may include the user interface 117, the processing system 114, and/or the memory component 115 of the apparatus 110.

The at least one sound symbol may be different from the another sound symbol. For example, the at least one sound symbol may be waterfall sound symbol and the another sound symbol may be a glass breaking sound. Also, the RV or the GRV may be different from the another RV or the another GRV. For example, if the at least one sound symbol is rendered as originating from left, the another sound symbol may be rendered as originating from right.

Further, the at least one sound symbol and the another sound symbol may be rendered contemporaneously. For example, the at least one sound symbol and the another sound symbol may be rendered simultaneously or at least where rendering of the at least one sound symbol and the another sound symbol overlap with each at least partially. More generally, there may be a window of time defined in which both the at least one sound symbol and the another sound symbol will be rendered, and the user may choose between the sound symbols (e.g., by turning towards the rendered sound) during or immediately subsequent to the window of time being passed.

Referring back to FIG. 10, in block 1020, the device (e.g., RG/GRV system 413, AR/XR system 414, IMU 416) may determine a sequence of one or more vectors selected by the user, also referred to as selected vector sequence for clarity. Each vector of the selected vector sequence may be an RV or a GRV. Means for performing block 1020 may include the user interface 117, the processing system 114, and/or the memory component 115 of the apparatus 110.

In block 1020, the user may be changing the orientation of the device to enter the password within the virtual space. Note that block 1020 may apply to when the password includes one or more visual symbols or to when the password includes one or more sound symbols.

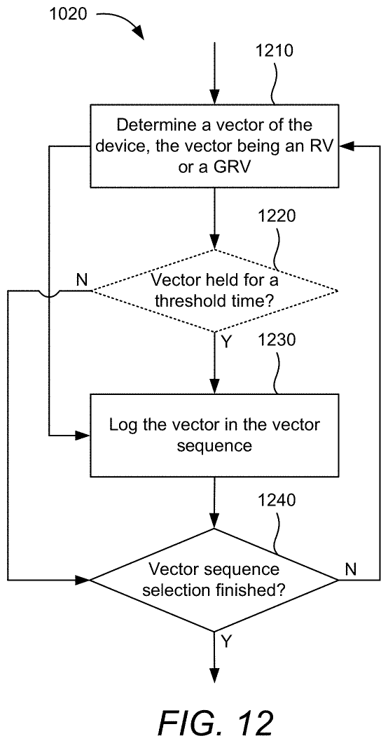

FIG. 12 illustrates a flow chart of an example process that may be performed by the device to implement block 1020. In block 1210, the device (e.g., RV/GRV system 413, IMU 416) may determine a vector of the device, the vector being an RV or a GRV. Means for performing block 1210 may include the measurement component 116, the processing system 114, and/or the memory component 115 of the apparatus 110.

In block 1230, the device may log the vector in the selected vector sequence. Means for performing block 1230 may include the processing system 114 and/or the memory component 115 of the apparatus 110.

In block 1240, the device may determine whether the vector sequence selection has finished. If not (‘N’ branch from block 1240), the device may go back to block 1210. Otherwise, (‘Y’ branch from block 1240), the device may exit the process of implementing block 1020. Means for performing block 1240 may include the processing system 114 and/or the memory component 115 of the apparatus 110.

In an aspect, it may be desirable to verify that the users have intended the selection of the symbol within the virtual scene. One way for the users to show intent is for the user to explicitly indicate (not shown), e.g., through a user interface, the selection of the symbol. For example, if the virtual scene is displayed on a display of a device such as a touch screen of a mobile device, the user may indicate by tapping the selected symbol on the screen. As another example, if the virtual scene is displayed on smart glasses such as AR/XR glasses, then the user may orient the glasses to center the selected symbol within view and tapping on a button input.

Another way is for the user to orient the device on the selected symbol and maintain the orientation for a threshold time, e.g., such as two seconds. Thus, after block 1210, the device (e.g., RV/GRV system 413, IMU 416) in block 1220 may determine whether the vector is held for the threshold time. Means for performing block 1220 may include the measurement component 116, the processing system 114, and/or the memory component 115 of the apparatus 110.

If the vector is held for the threshold time (‘Y’ branch from block 1220), then the device may proceed to block 1230 to log the vector. Otherwise (‘N’ branch from block 1220), the device may proceed to block 1240 to determine whether the vector sequence selection process is finished.

Referring back to FIG. 10, in block 1030, the device (e.g., RV/GRV system 413, AR/XR system 414) may determine whether the selected vector sequence matches the password. Means for performing block 1030 may include the processing system 114 and/or the memory component 115 of the apparatus 110. Note that block 1030 may also apply to when the password includes one or more visual symbols or to when the password includes one or more sound symbols.

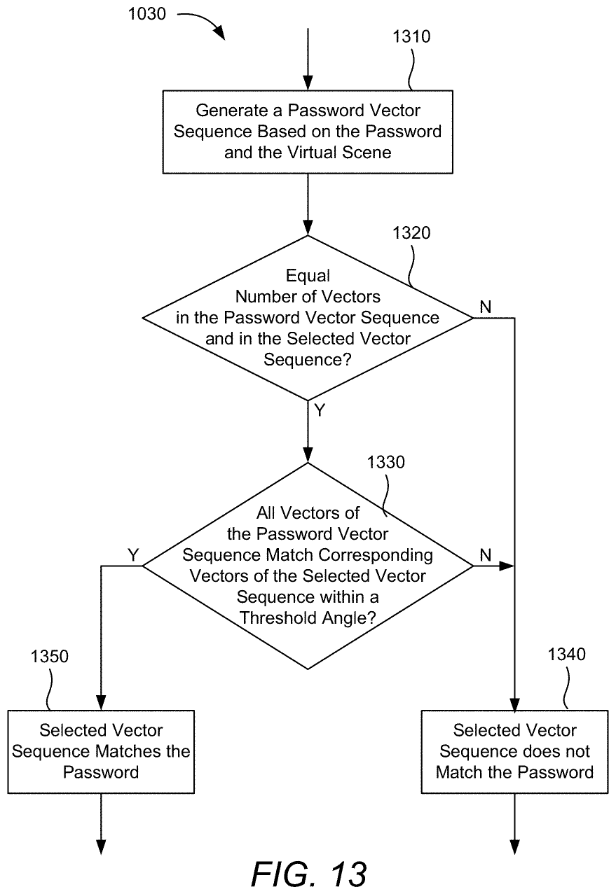

FIG. 13 illustrates a flow chart of an example process that may be performed by the device to implement block 1030. In this process, a vector sequence corresponding to the password—the password vector sequence—may be compared against the selected vector sequence. In block 1310, the device (e.g., RV/GRV system 413, AR/XR system 414) may generate the password vector sequence comprising one or more vectors based on the password and the virtual scene. Each vector of the password vector sequence may be an RV or a GRV. Means for performing block 1310 may include the processing system 114 and/or the memory component 115 of the apparatus 110.

Recall that the symbols distributed in the virtual scene includes the symbols of the password. The device may then determine, for each symbol (visual or sound) of the password, a corresponding vector within the virtual scene. In an aspect, the password vector sequence may be the sequence of RVs or GRVs randomly generated in block 1110 and/or in block 1115. Thus, password vector sequence may be generated in block 1310.

In block 1320, the device may determine whether a number of vectors in the password vector sequence and a number of vectors in the selected vector sequence are equal. Means for performing block 1320 may include the processing system 114 and/or the memory component 115 of the apparatus 110.

If the number of vectors of the password and selected vector sequences are not equal (‘N’ branch from block 1320), the device in block 1340 may determine that the selected vector sequence does not match the password. Means for performing block 1340 may include the processing system 114 and/or the memory component 115 of the apparatus 110.

If the number of vectors of the password and selected vector sequences are equal (‘Y’ branch from block 1320), then in block 1330, the device may determine whether all vectors of the password vector sequence match corresponding vectors of the selected vector sequence within a threshold angle. For example, for a vector of the selected vector sequence to match a corresponding vector of the password vector sequence, the vector of the selected vector sequence should be within the threshold angle of the corresponding vector of the password vector sequence. The threshold angle may be set according to a desired level of security. For example, if the security requirement is high, the threshold angle may be set low, i.e., set to be narrow. This implies that a greater precision is required from the user when the selected vector sequence is generated. Means for performing block 1330 may include the processing system 114 and/or the memory component 115 of the apparatus 110.

If not all vectors of the password vector sequence match the corresponding vectors of the selected vector sequence (‘N’ branch from block 1330), the device may proceed to block 1340 to determine that the selected vector sequence does not match the password. Means for performing block 1340 may include the processing system 114 and/or the memory component 115 of the apparatus 110.

If all vectors of the password vector sequence do match the corresponding vectors of the selected vector sequence (‘Y’ branch from block 1330), then in block 1350, the device may determine that the selected vector sequence does match the password. Means for performing block 1350 may include the processing system 114 and/or the memory component 115 of the apparatus 110.

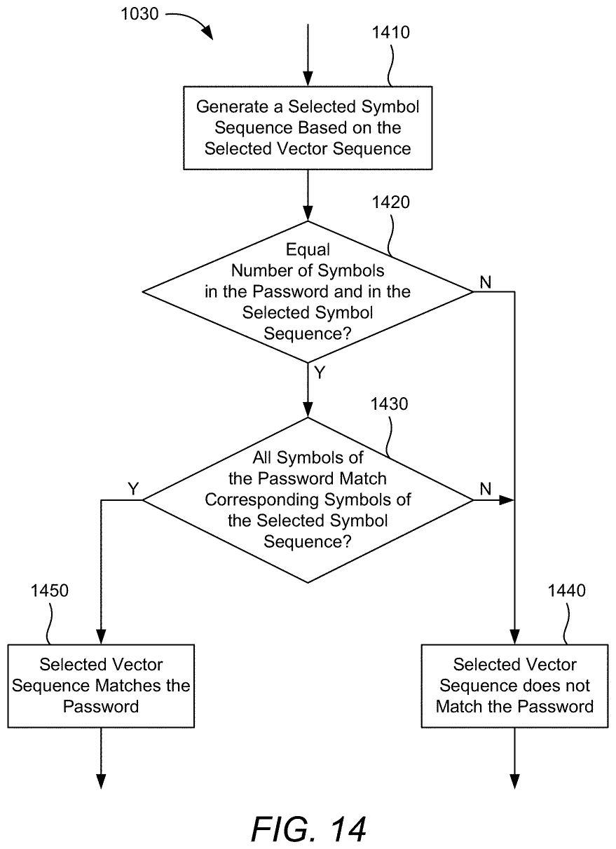

FIG. 14 illustrates a flow chart of another example process that may be performed by the device to implement block 1030. In this process, a sequence of symbols corresponding to the selected vector sequence—the selected symbol sequence—may be compared against the password. In block 1410, the device (e.g., RV/GRV system 413, AR/XR system 414) may generate the selected symbol sequence comprising one or more symbols based on the selected vector sequence. Means for performing block 1410 may include the processing system 114 and/or the memory component 115 of the apparatus 110.

For visual symbols, each symbol of the selected symbol sequence may be a visual symbol located within a threshold angle of a position in the virtual scene indicated by a corresponding vector of the selected vector sequence. For sound symbols, each symbol of the selected symbol sequence may be a sound symbol rendered within the threshold angle within the virtual scene. The device may then determine, for each vector of the selected vector sequence, a symbol (visual or sound) located at the position in the virtual scene within the threshold angle. Thus, selected symbol sequence may be generated in block 1410. Again, the threshold angle may be set based on a desired level of security.

In block 1420, the device may determine whether a number of symbols in the password and a number of symbols in the selected symbol sequence are equal. Means for performing block 1420 may include the processing system 114 and/or the memory component 115 of the apparatus 110.

If the number of symbols in the password and in the selected symbol sequence are not equal (‘N’ branch from block 1420), the device in block 1440 may determine that the selected vector sequence does not match the password. Means for performing block 1440 may include the processing system 114 and/or the memory component 115 of the apparatus 110.

If the number of symbols in the password and in the selected symbol sequence are equal (‘Y’ branch from block 1420), then in block 1430, the device may determine whether all symbols of the password match corresponding symbols of the selected symbol sequence.

If not all symbols of the password match the corresponding symbols of the selected symbol sequence (‘N’ branch from block 1430), the device may proceed to block 1440 to determine that the selected vector sequence does not match the password.

If all symbols of the password do match the corresponding symbols of the selected symbol sequence (‘Y’ branch from block 1430), then in block 1450, the device may determine that the selected vector sequence does match the password. Means for performing block 1450 may include the processing system 114 and/or the memory component 115 of the apparatus 110.

Referring back to FIG. 10, in block 1040, the device may authenticate the user when the selected vector sequence matches the password. Means for performing block 1040 may include the processing system 114 and/or the memory component 115 of the apparatus 110.

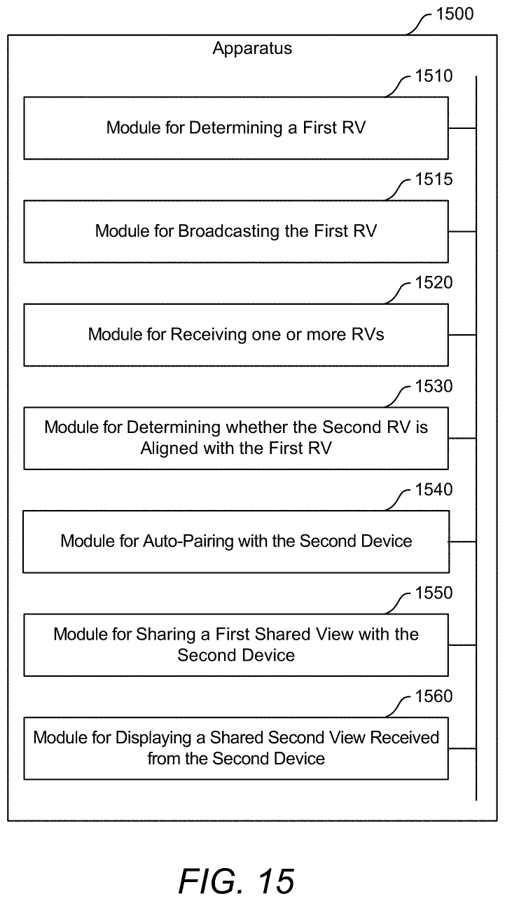

FIG. 15 illustrates an example device 1500 represented as a series of interrelated functional modules connected by a common bus. Each of the modules may be implemented in hardware or as a combination of hardware and software. For example, the modules may perform the methods and processes of FIGS. 5-7 and may be implemented as any combination of the modules of the systems/devices 110, 120, 410, 420 of FIGS. 1 and 4. A module 1510 for determining a first RV may correspond at least in some aspects to a measurement component (e.g., measurement component 116), a processor (e.g., processing system 114), and/or a memory (e.g., memory component 115). A module 1515 for broadcasting the first RV may correspond at least in some aspects to a communicator (e.g., communicator 111), a processor (e.g., processing system 114), and/or a memory (e.g., memory component 115). A module 1520 for receiving one or more RVs may correspond at least in some aspects to a communicator (e.g., communicator 111), a processor (e.g., processing system 114), and/or a memory (e.g., memory component 115). A module 1530 for determining whether the second RV is aligned with the first RV may correspond at least in some aspects to a processor (e.g., processing system 114) and/or a memory (e.g., memory component 115). A module 1540 for auto-pairing with the second device may correspond at least in some aspects to a communicator (e.g., communicator 111), a processor (e.g., processing system 114), and/or a memory (e.g., memory component 115). A module 1550 for sharing a first shared view with the second device may correspond at least in some aspects to a communicator (e.g., communicator 111), a processor (e.g., processing system 114), and/or a memory (e.g., memory component 115). A module 1560 for displaying a shared second view received from the second device may correspond at least to a communicator (e.g., communicator 111), a user interface (e.g., user interface 117), a processor (e.g., processing system 114), and/or a memory (e.g., memory component 115).

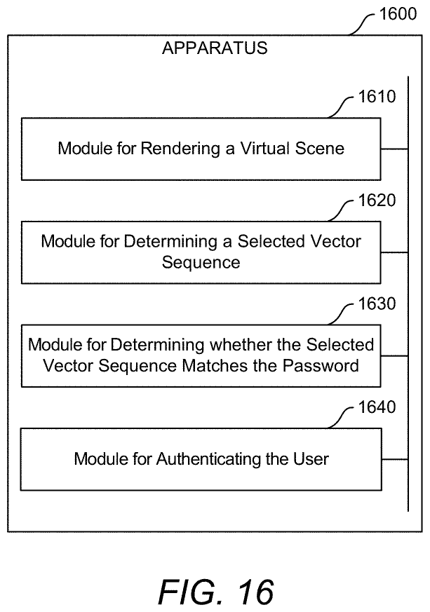

FIG. 16 illustrates an example device 1600 represented as a series of interrelated functional modules connected by a common bus. Each of the modules may be implemented in hardware or as a combination of hardware and software. For example, the modules may perform the methods and processes of FIGS. 10-14 and may be implemented as any combination of the modules of the systems/devices 110, 120, 410, 420 of FIGS. 1 and 4. A module 1610 for rendering a virtual scene may correspond at least in some aspects to a user interface (e.g., user interface 117), a processor (e.g., processing system 114) and/or a memory (e.g., memory component 115). A module 1620 for determining a selected vector sequence may correspond at least in some aspects to a processor (e.g., processing system 114) and/or a memory (e.g., memory component 115). A module 1630 for determining whether the selected vector sequence matches the password may correspond at least in some aspects to a processor (e.g., processing system 114) and/or a memory (e.g., memory component 115). A module 1640 for authenticating the user may correspond at least in some aspects to a user interface (e.g., user interface 117), a processor (e.g., processing system 114) and/or a memory (e.g., memory component 115).

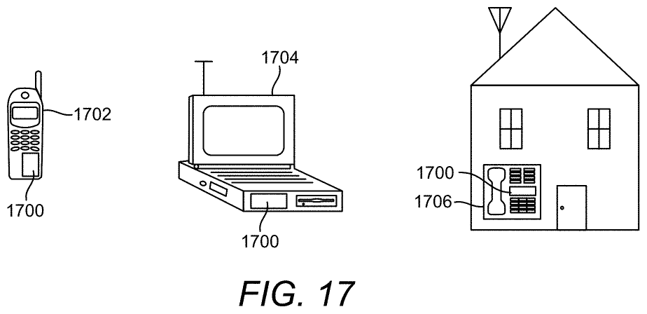

FIG. 17 illustrates various electronic devices that may be integrated with any of the aforementioned systems/devices in accordance with various aspects of the disclosure. For example, a mobile phone device 1702, a laptop computer device 1704, and a terminal device 1706 may include the RV/GRV authentication device 1700. The devices 1702, 1704, 1706 illustrated in FIG. 17 are merely exemplary. Other electronic devices may also include, but not limited to, a group of devices (e.g., electronic devices) that includes mobile devices, hand-held personal communication systems (PCS) units, portable data units such as personal digital assistants, global positioning system (GPS) enabled devices, navigation devices, set top boxes, music players, video players, entertainment units, fixed location data units such as meter reading equipment, communications devices, smartphones, tablet computers, computers, wearable devices, servers, routers, electronic devices implemented in automotive vehicles (e.g., autonomous vehicles), an Internet of things (IoT) device or any other device that stores or retrieves data or computer instructions or any combination thereof.

Implementation examples are described in the following numbered clauses:

Clause 1: A method of a first device, the method comprising: determining, utilizing an internal measurement unit (IMU), a first rotation vector (RV) of a first camera of the first device; receiving one or more RVs from one or more devices including a second RV from a second device, the second RV being an RV of a second camera of the second device; determining whether the second RV is aligned with the first RV; and auto-pairing with the second device when the second RV is aligned with the first RV.

Clause 2: The method of clause 1, wherein determining whether the second RV is aligned with the first RV comprises: determining that the second RV is aligned with the first RV when the first and second RVs have comparable orientations, the first and second RVs having comparable orientation if an orientation of the first RV is opposite to an orientation of the second RV within a threshold angle, or the orientation of the first RV is same as the orientation of the second RV within the threshold angle.

Clause 3: The method of clause 2, wherein determining whether the second RV is aligned with the first RV further comprises: determining that the second RV is aligned with the first RV when the orientations of the first and second RVs remain comparable for a threshold time.

Clause 4: The method of clause 1, wherein determining whether the second RV is aligned with the first RV comprises: determining whether the first and second RVs have comparable orientations, the first and second RVs having comparable orientation if an orientation of the first RV is opposite to an orientation of the second RV within a threshold angle, or the orientation of the first RV is same as the orientation of the second RV within the threshold angle; and determining whether an object associated with the second device is detected within a first camera view, the first camera view being a view of the first camera, wherein it is determined that the second RV is aligned with the first RV when the first and second RVS have comparable orientations and the object associated with the second device is detected within the first camera view.

Clause 5: The method of clause 4, wherein the object associated with the second device is any one or more of a face, a wearable unit, and a mobile device.

Clause 6: The method of clause 5, wherein the wearable unit are smart glasses.

Clause 7: The method of any of clauses 1-6, further comprising: broadcasting the first RV.

Clause 8: The method of any of clauses 1-7, further comprising: sharing, subsequent to auto-pairing with the second device, a first shared view with the second device, the first shared view being a first camera view or a first rendered view, the first camera view being a view of the first camera, and the first rendered view being a view after rendering the first camera view.

Clause 9: The method of clause 8, wherein the first rendered view is an augmented reality (AR) view of the first camera view, an extended reality (XR) view of the first camera view, or both.

Clause 10: The method of any of clauses 1-9, further comprising: displaying, subsequent to auto-pairing with the second device, a second shared view received from the second device, the second shared view being a second camera view or a second rendered view, the second camera view being a view of the second camera, and the second rendered view being a view after rendering the second camera view.

Clause 11: A method of a device, the method comprising: rendering a virtual scene based on a password of a user, the password comprising a sequence of one or more symbols, the one or more symbols comprising one or more visual symbols, one or more sound symbols, or both; determining a selected vector sequence selected by the user within the virtual scene, the selected vector sequence comprising a sequence of one or more vectors, each vector being a rotation vector (RV) or a game rotation vector (GRV); determining whether the selected vector sequence matches the password; and authenticating the user when the selected vector sequence matches the password.

Clause 12: The method of clause 11, wherein the password comprises the one or more visual symbols, and wherein in rendering the virtual scene comprises: distributing the one or more visual symbols of the password throughout the virtual scene.

Clause 13: The method of clause 12, wherein rendering the virtual scene further comprises: distributing one or more visual symbols that are not included in the password throughout the virtual scene.

Clause 14: The method of any of clauses 11-13, wherein the password comprises the one or more sound symbols, and wherein rendering the virtual scene comprises: rendering, for each sound symbol of the password, the sound symbol in an RV or a GRV determined for the sound symbol; and rendering, for at least one sound symbol of the password, another sound symbol in another RV or another GRV determined for the another sound symbol, the at least one sound symbol and the another sound symbol being rendered contemporaneously, the at least one sound symbol being different from the another sound symbol, and the RV or the GRV being different from the another RV or the another GRV.

Clause 15: The method of any of clauses 11-14, wherein determining the selected vector sequence comprises: determining a vector of the device, the vector being an RV or a GRV; and logging the vector in the selected vector sequence, wherein determining and logging the vector repeats until a vector sequence selection process is finished.

Clause 16: The method of clause 15, wherein determining the selected vector sequence further comprises: logging the vector in the selected vector sequence when the vector is held for a threshold time.

Clause 17: The method of any of clauses 11-16, wherein determining whether the selected vector sequence matches the password comprises: generating a password vector sequence based on the password and the virtual scene, the password vector sequence comprising one or more vectors, each vector being an RV or a GRV; determining whether a number of vectors in the password vector sequence and a number of vectors in the selected vector sequence are equal; determining whether all vectors of the password vector sequence match corresponding vectors of the selected vector sequence within a threshold angle; determining that the selected vector sequence does not match the password when it is determined that the number of vectors in the password vector sequence and the number of vectors in the selected vector sequence are not equal, or not all vectors of the password vector sequence match the corresponding vectors of the selected vector sequence within the threshold angle, or both; and determining that the selected vector sequence does match the password when it is determined that the number of vectors in the password vector sequence and the number of vectors in the selected vector sequence are equal, and all vectors of the password vector sequence match the corresponding vectors of the selected vector sequence within the threshold angle.

Clause 18: The method of clause 17, wherein the threshold angle is set based on a level of security.

Clause 19: The method of any of clauses 11-16, wherein determining whether the selected vector sequence matches the password comprises: generating a selected symbol sequence comprising one or more symbols based on the selected vector sequence, each symbol of the selected symbol sequence being a symbol located within a threshold angle of a position in the virtual scene indicated by a corresponding vector of the selected vector sequence; determining whether a number of symbols in the password and a number of symbols in the selected symbol sequence are equal; determining whether all symbols of the password match corresponding symbols of the selected symbol sequence; determining that the selected vector sequence does not match the password when it is determined that the number of symbols in the password and the number of symbols in the selected symbol sequence are not equal, or not all symbols of the password match the corresponding symbols of the selected symbol sequence, or both; and determining that the selected vector sequence does match the password when it is determined that the number of symbols in the password and the number of symbols in the selected symbol sequence are equal, and all symbols of the password match the corresponding symbols of the selected symbol sequence.

Clause 20: The method of clause 19, wherein the threshold angle is set based on a level of security.

Clause 21: A first device comprising at least one means for performing a method of any of clauses 1-10.

Clause 22: A first device comprising a memory and a processor communicatively connected to the memory, the processor being configured perform a method of any of clauses 1-10.

Clause 23: A non-transitory computer-readable medium storing code for a first device comprising a memory and a processor communicatively connected to the memory, and instructions stored in the memory and executable by the processor to cause the first device to perform a method of any of clauses 1-10.

Clause 24: A first device comprising at least one means for performing a method of any of clauses 11-20.

Clause 25: A first device comprising a memory and a processor communicatively connected to the memory, the processor being configured perform a method of any of clauses 11-20.

Clause 26: A non-transitory computer-readable medium storing code for a first device comprising a memory and a processor communicatively connected to the memory, and instructions stored in the memory and executable by the processor to cause the first device to perform a method of any of clauses 11-20.

As used herein, the terms “user equipment” (or “UE”), “user device,” “user terminal,” “client device,” “communication device,” “wireless device,” “wireless communications device,” “handheld device,” “mobile device,” “mobile terminal,” “mobile station,” “handset,” “access terminal,” “subscriber device,” “subscriber terminal,” “subscriber station,” “terminal,” and variants thereof may interchangeably refer to any suitable mobile or stationary device that can receive wireless communication and/or navigation signals. These terms include, but are not limited to, a music player, a video player, an entertainment unit, a navigation device, a communications device, a smartphone, a personal digital assistant, a fixed location terminal, a tablet computer, a computer, a wearable device, a laptop computer, a server, an automotive device in an automotive vehicle, and/or other types of portable electronic devices typically carried by a person and/or having communication capabilities (e.g., wireless, cellular, infrared, short-range radio, etc.). These terms are also intended to include devices which communicate with another device that can receive wireless communication and/or navigation signals such as by short-range wireless, infrared, wireline connection, or other connection, regardless of whether satellite signal reception, assistance data reception, and/or position-related processing occurs at the device or at the other device. In addition, these terms are intended to include all devices, including wireless and wireline communication devices, that are able to communicate with a core network via a radio access network (RAN), and through the core network the UEs can be connected with external networks such as the Internet and with other UEs. Of course, other mechanisms of connecting to the core network and/or the Internet are also possible for the UEs, such as over a wired access network, a wireless local area network (WLAN) (e.g., based on IEEE 802.11, etc.) and so on. UEs can be embodied by any of a number of types of devices including but not limited to printed circuit (PC) cards, compact flash devices, external or internal modems, wireless or wireline phones, smartphones, tablets, tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

The word “exemplary” is used herein to mean “serving as an example, instance, or illustration.” Any details described herein as “exemplary” is not to be construed as advantageous over other examples. Likewise, the term “examples” does not mean that all examples include the discussed feature, advantage or mode of operation. Furthermore, a particular feature and/or structure can be combined with one or more other features and/or structures. Moreover, at least a portion of the apparatus described herein can be configured to perform at least a portion of a method described herein.

It should be noted that the terms “connected,” “coupled,” or any variant thereof, mean any connection or coupling, either direct or indirect, between elements, and can encompass a presence of an intermediate element between two elements that are “connected” or “coupled” together via the intermediate element unless the connection is expressly disclosed as being directly connected.

Any reference herein to an element using a designation such as “first,” “second,” and so forth does not limit the quantity and/or order of those elements. Rather, these designations are used as a convenient method of distinguishing between two or more elements and/or instances of an element. Also, unless stated otherwise, a set of elements can comprise one or more elements.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Nothing stated or illustrated depicted in this application is intended to dedicate any component, action, feature, benefit, advantage, or equivalent to the public, regardless of whether the component, action, feature, benefit, advantage, or the equivalent is recited in the claims.

In the detailed description above it can be seen that different features are grouped together in examples. This manner of disclosure should not be understood as an intention that the claimed examples have more features than are explicitly mentioned in the respective claim. Rather, the disclosure may include fewer than all features of an individual example disclosed. Therefore, the following claims should hereby be deemed to be incorporated in the description, wherein each claim by itself can stand as a separate example. Although each claim by itself can stand as a separate example, it should be noted that-although a dependent claim can refer in the claims to a specific combination with one or one or more claims-other examples can also encompass or include a combination of said dependent claim with the subject matter of any other dependent claim or a combination of any feature with other dependent and independent claims. Such combinations are proposed herein, unless it is explicitly expressed that a specific combination is not intended. Furthermore, it is also intended that features of a claim can be included in any other independent claim, even if said claim is not directly dependent on the independent claim.

It should furthermore be noted that methods, systems, and apparatus disclosed in the description or in the claims can be implemented by a device comprising means for performing the respective actions and/or functionalities of the methods disclosed.

Furthermore, in some examples, an individual action can be subdivided into one or more sub-actions or contain one or more sub-actions. Such sub-actions can be contained in the disclosure of the individual action and be part of the disclosure of the individual action.

While the foregoing disclosure shows illustrative examples of the disclosure, it should be noted that various changes and modifications could be made herein without departing from the scope of the disclosure as defined by the appended claims. The functions and/or actions of the method claims in accordance with the examples of the disclosure described herein need not be performed in any particular order. Additionally, well-known elements will not be described in detail or may be omitted so as to not obscure the relevant details of the aspects and examples disclosed herein. Furthermore, although elements of the disclosure may be described or claimed in the singular, the plural is contemplated unless limitation to the singular is explicitly stated.

What is claimed is:

1. A first device comprising:
a memory;
a communicator; and
a processor communicatively connected to the memory and the communicator, the processor being configured to:
determine, utilizing an inertial measurement unit (IMU), a first rotation vector (RV) of a first camera of the first device;
receive one or more RVs from one or more devices including a second RV from a second device, the second RV being an RV of a second camera of the second device;
determine whether the second RV is aligned with the first RV; and
auto-pair with the second device when the second RV is aligned with the first RV.

2. The first device of claim 1, wherein in determining whether the second RV is aligned with the first RV, the processor is configured to:
determine that the second RV is aligned with the first RV when the first and second RVs have comparable orientations, the first and second RVs having comparable orientation if
an orientation of the first RV is opposite to an orientation of the second RV within a threshold angle, or
the orientation of the first RV is same as the orientation of the second RV within the threshold angle.

3. The first device of claim 2, wherein in determining whether the second RV is aligned with the first RV, the processor is further configured to:
determine that the second RV is aligned with the first RV when the orientations of the first and second RVs remain comparable for a threshold time.

4. The first device of claim 2, wherein in determining whether the second RV is aligned with the first RV, the processor is further configured to:
determine whether the first and second RVs have comparable orientations, the first and second RVs having comparable orientation if
an orientation of the first RV is opposite to an orientation of the second RV within a threshold angle, or
the orientation of the first RV is same as the orientation of the second RV within the threshold angle; and
determine whether an object associated with the second device is detected within a first camera view, the first camera view being a view of the first camera,
wherein it is determined that the second RV is aligned with the first RV when the first and second RVS have comparable orientations and the object associated with the second device is detected within the first camera view.

5. The first device of claim 4, wherein the object associated with the second device is any one or more of a face, a wearable unit, and a mobile device.

6. The first device of claim 5, wherein the wearable unit are smart glasses.

7. The first device of claim 1, wherein the processor is further configured to:
broadcast the first RV.

8. The first device of claim 1, wherein the processor is further configured to:
share, subsequent to auto-pairing with the second device, a first shared view with the second device, the first shared view being a first camera view or a first rendered view, the first camera view being a view of the first camera, and the first rendered view being a view after rendering the first camera view.

9. The first device of claim 8, wherein the first rendered view is an augmented reality (AR) view of the first camera view, an extended reality (XR) view of the first camera view, or both.

10. The first device of claim 1, wherein the processor is further configured to:
display, subsequent to auto-pairing with the second device, a second shared view received from the second device, the second shared view being a second camera view or a second rendered view, the second camera view being a view of the second camera, and the second rendered view being a view after rendering the second camera view.

11. A device comprising:
a memory;
a communicator; and
a processor communicatively connected to the memory and the communicator, the processor being configured to:
render a virtual scene based on a password of a user, the password comprising a sequence of one or more symbols, the one or more symbols comprising one or more visual symbols, one or more sound symbols, or both;
determine a selected vector sequence selected by the user within the virtual scene, the selected vector sequence comprising a sequence of one or more vectors, each vector being a rotation vector (RV) or a game rotation vector (GRV);
determine whether the selected vector sequence matches the password; and
authenticate the user when the selected vector sequence matches the password.

12. The device of claim 11,
wherein the password comprises the one or more visual symbols, and
wherein in rendering the virtual scene, the processor is configured to:
distribute the one or more visual symbols of the password throughout the virtual scene.

13. The device of claim 12, wherein in rendering the virtual scene, the processor is further configured to:
distribute one or more visual symbols that are not included in the password throughout the virtual scene.

14. The device of claim 11,
wherein the password comprises the one or more sound symbols, and
wherein in rendering the virtual scene, the processor is configured to:
render, for each sound symbol of the password, the sound symbol in an RV or a GRV determined for the sound symbol; and
render, for at least one sound symbol of the password, another sound symbol in another RV or another GRV determined for the another sound symbol, the at least one sound symbol and the another sound symbol being rendered contemporaneously, the at least one sound symbol being different from the another sound symbol, and the RV or the GRV being different from the another RV or the another GRV.

15. The device of claim 11, wherein in determining the selected vector sequence, the processor is configured to:
determine a vector of the device, the vector being an RV or a GRV; and
log the vector in the selected vector sequence,
wherein determining and logging the vector repeats until a vector sequence selection process is finished.

16. The device of claim 15, wherein in determining the selected vector sequence, the processor is further configured to:
log the vector in the selected vector sequence when the vector is held for a threshold time.

17. The device of claim 11, wherein in determining whether the selected vector sequence matches the password, the processor is configured to:
generate a password vector sequence based on the password and the virtual scene, the password vector sequence comprising one or more vectors, each vector being an RV or a GRV;
determine whether a number of vectors in the password vector sequence and a number of vectors in the selected vector sequence are equal;
determine whether all vectors of the password vector sequence match corresponding vectors of the selected vector sequence within a threshold angle;
determine that the selected vector sequence does not match the password when it is determined that
the number of vectors in the password vector sequence and the number of vectors in the selected vector sequence are not equal, or
not all vectors of the password vector sequence match the corresponding vectors of the selected vector sequence within the threshold angle, or
both; and
determine that the selected vector sequence does match the password when it is determined that
the number of vectors in the password vector sequence and the number of vectors in the selected vector sequence are equal, and
all vectors of the password vector sequence match the corresponding vectors of the selected vector sequence within the threshold angle.

18. The device of claim 17, wherein the threshold angle is set based on a level of security.

19. The device of claim 11, wherein in determining whether the selected vector sequence matches the password, the processor is configured to:
generate a selected symbol sequence comprising one or more symbols based on the selected vector sequence, each symbol of the selected symbol sequence being a symbol located within a threshold angle of a position in the virtual scene indicated by a corresponding vector of the selected vector sequence;
determine whether a number of symbols in the password and a number of symbols in the selected symbol sequence are equal;
determine whether all symbols of the password match corresponding symbols of the selected symbol sequence;
determine that the selected vector sequence does not match the password when it is determined that
the number of symbols in the password and the number of symbols in the selected symbol sequence are not equal, or
not all symbols of the password match the corresponding symbols of the selected symbol sequence, or
both; and
determine that the selected vector sequence does match the password when it is determined that
the number of symbols in the password and the number of symbols in the selected symbol sequence are equal, and
all symbols of the password match the corresponding symbols of the selected symbol sequence.

20. The device of claim 19, wherein the threshold angle is set based on a level of security.

21. A method of a first device, the method comprising:
determining, utilizing an inertial measurement unit (IMU), a first rotation vector (RV) of a first camera of the first device;
receiving one or more RVs from one or more devices including a second RV from a second device, the second RV being an RV of a second camera of the second device;
determining whether the second RV is aligned with the first RV; and
auto-pairing with the second device when the second RV is aligned with the first RV.

22. The method of claim 21, wherein determining whether the second RV is aligned with the first RV comprises:
determining that the second RV is aligned with the first RV when the first and second RVs have comparable orientations, the first and second RVs having comparable orientation if
an orientation of the first RV is opposite to an orientation of the second RV within a threshold angle, or
the orientation of the first RV is same as the orientation of the second RV within the threshold angle.

23. The method of claim 21, wherein determining whether the second RV is aligned with the first RV comprises:
determining whether the first and second RVs have comparable orientations, the first and second RVs having comparable orientation if
an orientation of the first RV is opposite to an orientation of the second RV within a threshold angle, or
the orientation of the first RV is same as the orientation of the second RV within the threshold angle; and
determining whether an object associated with the second device is detected within a first camera view, the first camera view being a view of the first camera,
wherein it is determined that the second RV is aligned with the first RV when the first and second RVS have comparable orientations and the object associated with the second device is detected within the first camera view.

24. The method of claim 21, further comprising:
sharing, subsequent to auto-pairing with the second device, a first shared view with the second device, the first shared view being a first camera view or a first rendered view, the first camera view being a view of the first camera, and the first rendered view being a view after rendering the first camera view.

25. The method of claim 24, wherein the first rendered view is an augmented reality (AR) view of the first camera view, an extended reality (XR) view of the first camera view, or both.

26. A method of a device, the method comprising:
rendering a virtual scene based on a password of a user, the password comprising a sequence of one or more symbols, the one or more symbols comprising one or more visual symbols, one or more sound symbols, or both;
determining a selected vector sequence selected by the user within the virtual scene, the selected vector sequence comprising a sequence of one or more vectors, each vector being a rotation vector (RV) or a game rotation vector (GRV);
determining whether the selected vector sequence matches the password; and
authenticating the user when the selected vector sequence matches the password.

27. The method of claim 26,
wherein when the password comprises the one or more visual symbols, rendering the virtual scene comprises:
distributing the one or more visual symbols of the password throughout the virtual scene, and
wherein when the password comprises the one or more sound symbols, rendering the virtual scene comprises:
rendering, for each sound symbol of the password, the sound symbol in an RV or a GRV determined for the sound symbol; and
rendering, for at least one sound symbol of the password, another sound symbol in another RV or another GRV determined for the another sound symbol, the at least one sound symbol and the another sound symbol being rendered contemporaneously, the at least one sound symbol being different from the another sound symbol, and the RV or the GRV being different from the another RV or the another GRV.

28. The method of claim 26, wherein determining the selected vector sequence comprises:
determining a vector of the device, the vector being an RV or a GRV; and
logging the vector in the selected vector sequence,
wherein determining and logging the vector repeats until a vector sequence selection process is finished.

29. The method of claim 26, wherein determining whether the selected vector sequence matches the password comprises:
generating a password vector sequence based on the password and the virtual scene, the password vector sequence comprising one or more vectors, each vector being an RV or a GRV;
determining whether a number of vectors in the password vector sequence and a number of vectors in the selected vector sequence are equal;
determining whether all vectors of the password vector sequence match corresponding vectors of the selected vector sequence within a threshold angle;
determining that the selected vector sequence does not match the password when it is determined that
the number of vectors in the password vector sequence and the number of vectors in the selected vector sequence are not equal, or
not all vectors of the password vector sequence match the corresponding vectors of the selected vector sequence within the threshold angle, or
both; and
determining that the selected vector sequence does match the password when it is determined that
the number of vectors in the password vector sequence and the number of vectors in the selected vector sequence are equal, and
all vectors of the password vector sequence match the corresponding vectors of the selected vector sequence within the threshold angle.

30. The method of claim 26, wherein determining whether the selected vector sequence matches the password comprises:
generating a selected symbol sequence comprising one or more symbols based on the selected vector sequence, each symbol of the selected symbol sequence being a symbol located within a threshold angle of a position in the virtual scene indicated by a corresponding vector of the selected vector sequence;
determining whether a number of symbols in the password and a number of symbols in the selected symbol sequence are equal;
determining whether all symbols of the password match corresponding symbols of the selected symbol sequence;
determining that the selected vector sequence does not match the password when it is determined that
the number of symbols in the password and the number of symbols in the selected symbol sequence are not equal, or
not all symbols of the password match the corresponding symbols of the selected symbol sequence, or
both; and
determining that the selected vector sequence does match the password when it is determined that
the number of symbols in the password and the number of symbols in the selected symbol sequence are equal, and
all symbols of the password match the corresponding symbols of the selected symbol sequence.
